(19) United States
(12) Patent Application Publication
(10) Pub. No.: US 2005/0278538 A1
(43) Pub. Date: Dec. 15, 2005

(54) Method for naming and authentication

(76) Inventor: Stephan Dowys Fowler, London (GB)

Correspondence Address: STEPHAN FOWLER;CLINK SYSTEMS LTD, FERROWERS HOUSE, SHAFTESBURY PLACE, LONDON, EC2Y 8AA, GB

(21) Appl. No.: 10/895,860

(22) Filed: Jul. 22, 2004

(30) Foreign Application Priority Data
May 28, 2004 (GB) 0412006.9

(51) Int. Cl. H04L 9/00

(52) U.S. Cl. 713/182

(57) ABSTRACT

The naming and authentication of users by computer systems is carried out with an identifier with two functions. First, in its literal representation it acts as the system-level identity of the user. Second, it describes the location of cryptographic key material which may be used to authenticate the user claiming that identity. The method allows users to interact with secure servers or send messages to each other, on the basis that their identities cannot be easily masqueraded. The naming scheme is not hierarchical or centralised and the method is thus suited to contexts where many users may have specific relationships with many systems.

The invention relates to identifiers for users of computers systems in the context of processes where importance is placed on the authenticity of users, and their transactions or messages.

Secured computer systems require authenticable user identities in order to control access, receive commands, or accept messages. This is generally done by establishing credentials for each privileged user, typically a username that is unique on the particular system and an associated secret password. Depending on the situation, these credentials are either created by the user or the system. Both cases present various pitfalls.

In the case where the credentials are created by the user, the user may choose distinct credentials for each system that it registers with. This is the more secure approach, yet may present the user with the problem of managing a multitude of credentials for each system that it is registered with. Alternatively, the user may attempt to create identical credentials for some or all the systems that it registers with. This may not be possible, as the chosen credential may be already issued by, or may not be acceptable to, a particular system. In the event that the user succeeds in creating identical credentials on a number of systems, it must implicitly trust their integrity as they will all be in a position to masquerade as the user with respect to each other. In the case where a user's credentials are created by the system, the user may face the problem of managing a multitude of different credentials created by each system that it is registered with.

In both cases, the transmission of user credentials across communications channels may expose them to eavesdroppers who may subsequently be in a position to masquerade as the user.

The object of this invention is to provide a user with a credential that may be recognised by multiple systems, yet which does not enable those systems to masquerade as the user.

Accordingly, the credential consists of a single globally unique identifier which both identifies the user uniquely and describes the location of cryptographic material that may enable any compatible system to establish the authenticity of the user without the need for passwords to pass over communications channels.

The invention does not impose a naming hierarchy for these identifiers nor any requirement for their centralised creation or management, and is thus particularly suited to contexts where many users may have specific relationships with many distinct systems.

The preferred embodiments of the invention will now be described with reference to the accompanying drawings in which:

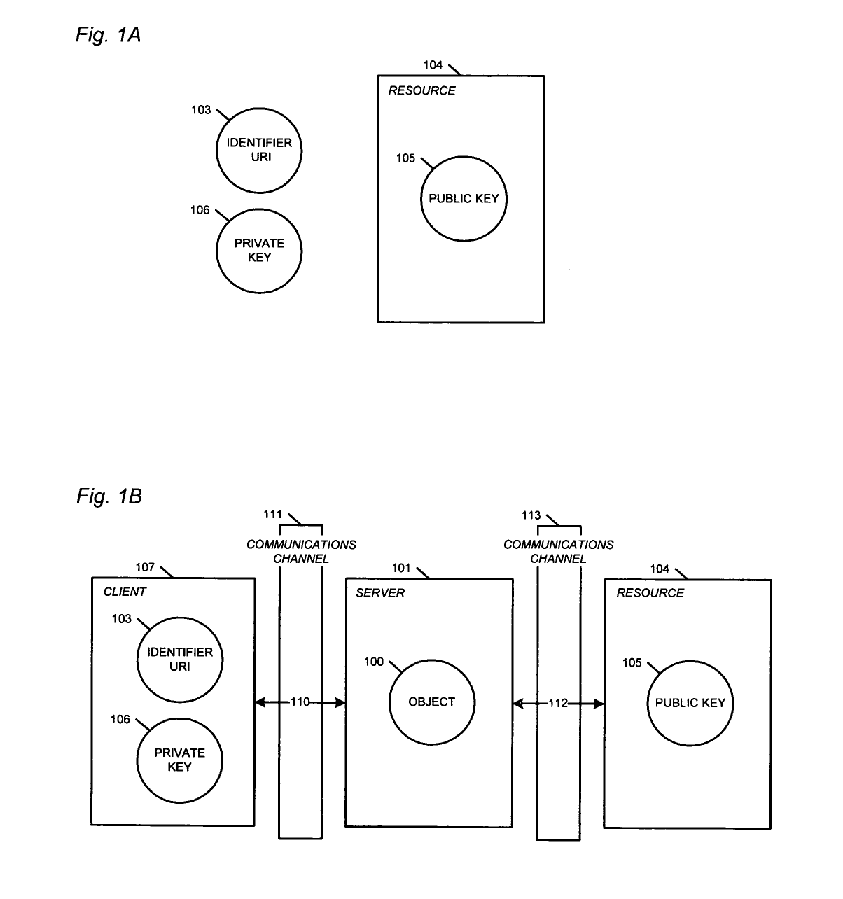

FIG. 1A shows the basic logical components of the user identifier;

FIG. 1B is a configuration for enabling a user to transact with a server;

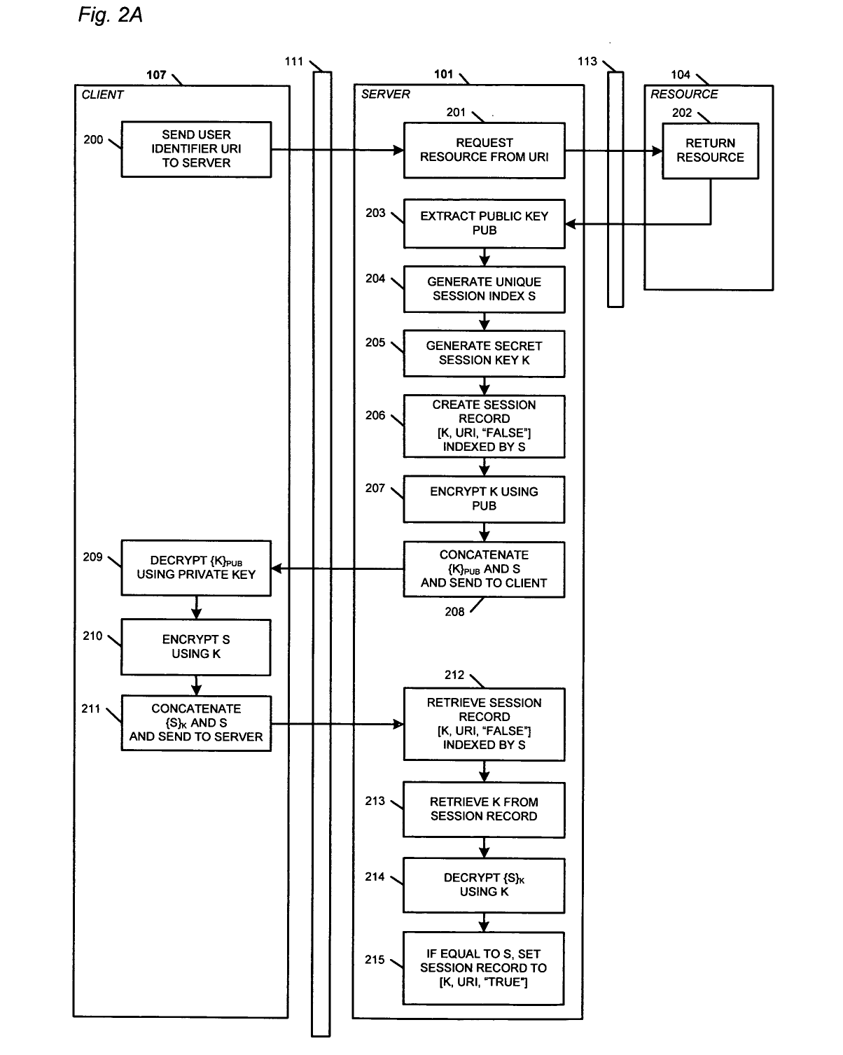

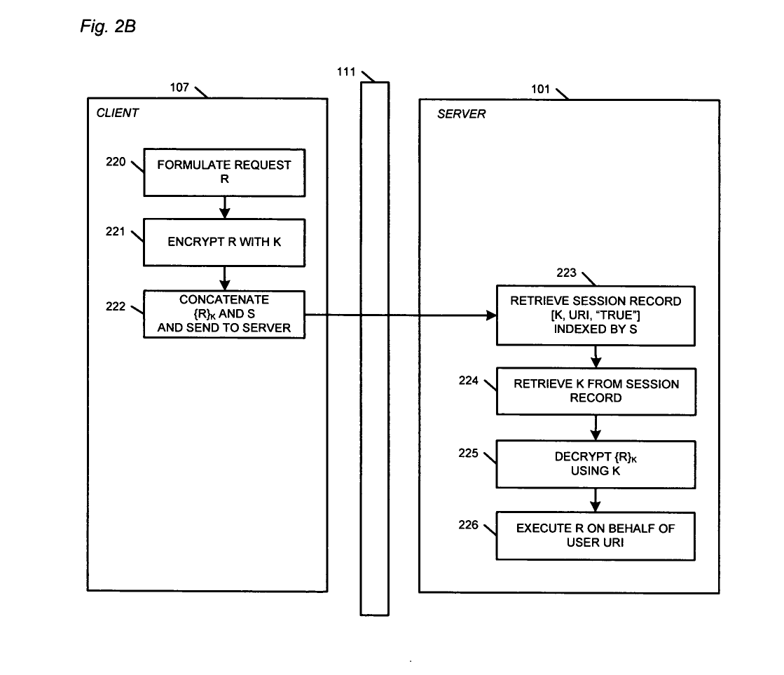

FIG. 2A shows the protocol for authenticating a user in the embodiment where communications are encrypted;

FIG. 2B shows the protocol for subsequent transactions in the embodiment where communications are encrypted;

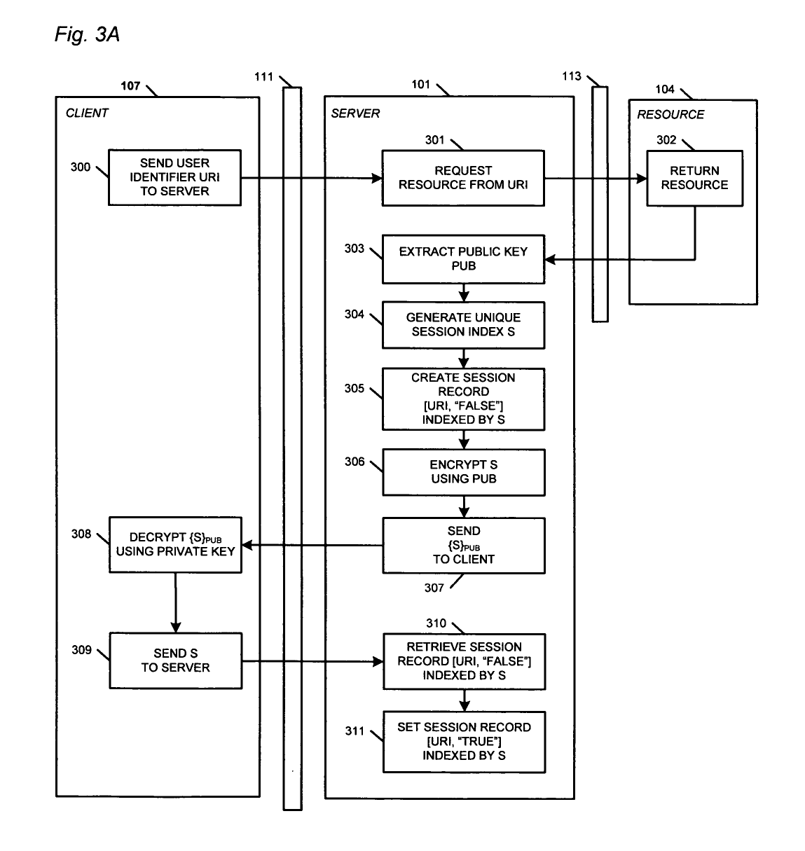

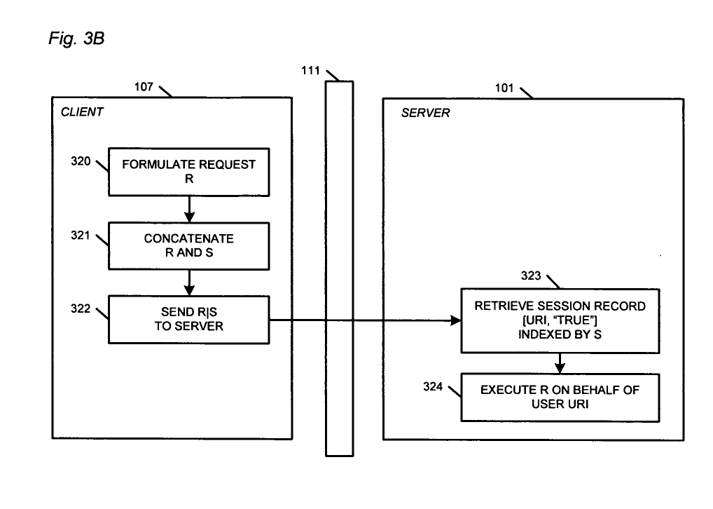

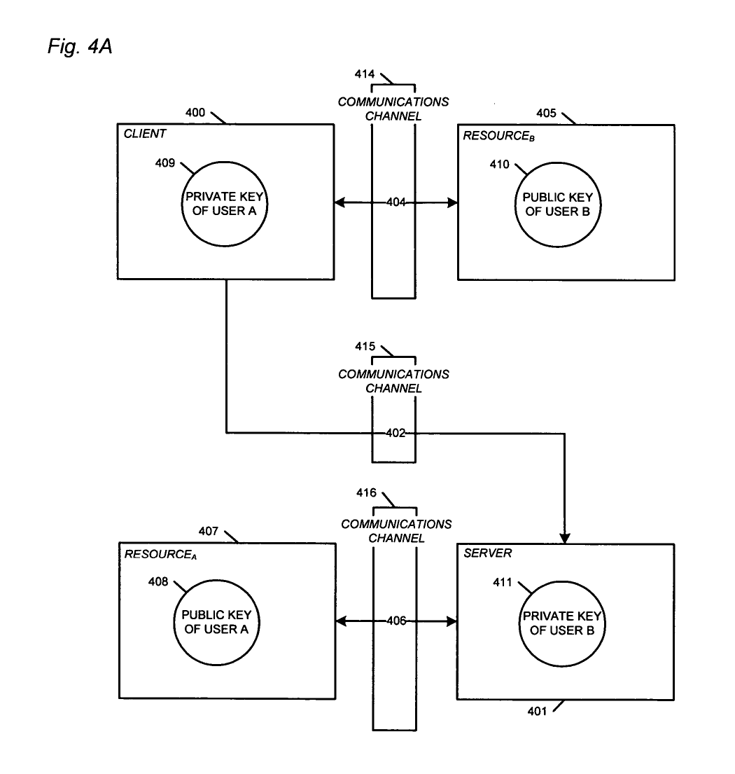

FIG. 3A shows the protocol for authenticating a user in the embodiment where communications are not encrypted;

FIG. 3B shows the protocol for subsequent transactions in the embodiment where communications are not encrypted;

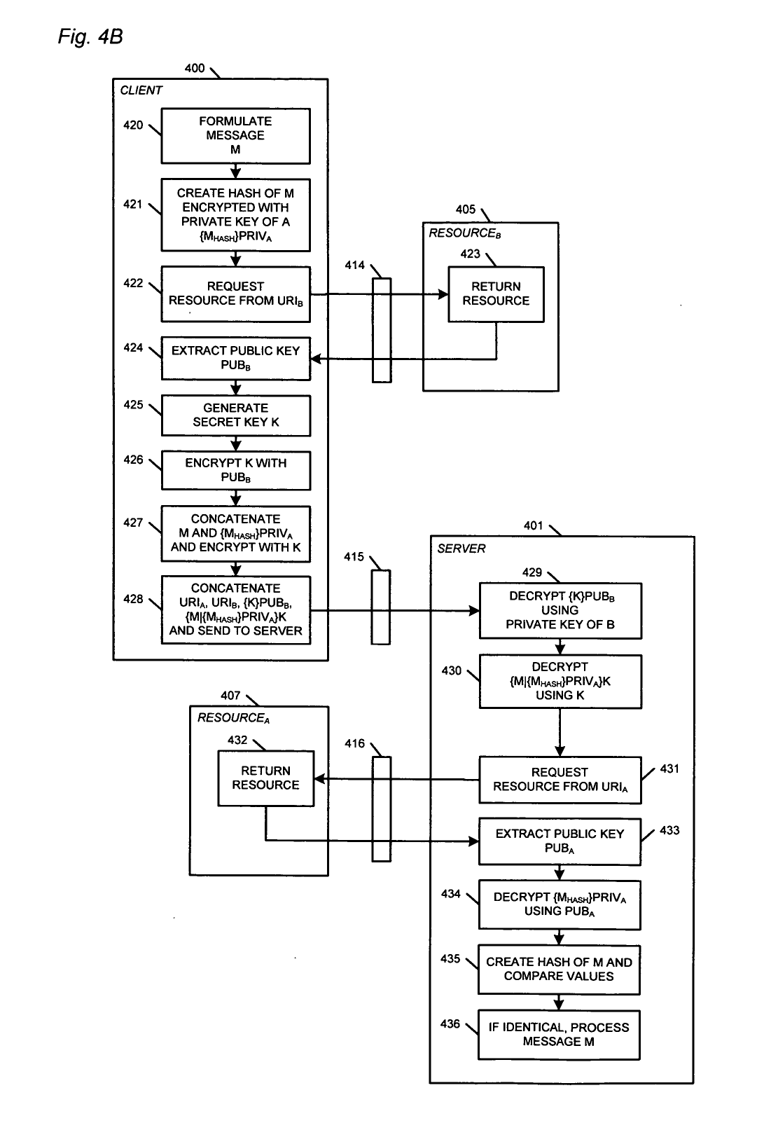

FIG. 4A is a configuration for the sending of messages between authenticated users;

FIG. 4B shows the protocol for the sending of messages between authenticated users.

The invention is a system and method for identifying and authenticating a user. It proposes a naming scheme, within which user names have two simultaneous roles. Firstly, the name acts as a user's unique identifier. Secondly, the name acts as a locator for cryptographic material that may enable other parties to authenticate the user.

The essential logical components of the present invention are illustrated schematically in FIG. 1A. A particular user is associated with an identifier 103. This is the user's identity wherever that user is represented in the system. The identifier 103 is formed as a Uniform Resource Identifier (URI) in accordance with Uniform Resource Identifiers (URI): Generic Syntax (T. Berners-Lee, R Fielding, U. C. Irvine, and L. Masinter, Request for Comments: 2396, IETF, Standards Track, August 1998).

The user's identity is the literal representation of this URI. This URI additionally describes a resource 104, typically via a representation of resource 104's location on a network. Resource 104 is machine-readable. It may be either a static file or the output of an automated process.

A resource 104 contains a public key 105 from a key pair generated for asymmetric key encryption. Asymmetric key encryption algorithms are conventional and a well known process in the art. The private key 106 that is paired with the public key 105 is separately stored.

In addition to containing the user's public key 105, the resource may contain additional information such as the network location of a servers or services under the authority of, or associated with, the user.

The user authentication model is predicated on two assumptions. Firstly, a user is assumed to be the authority over the location described by the user's identifier 103 and the resource 104 present at that location. Secondly, a user is assumed to be the authority over the private key 106 that pairs with the public key 105 present in the resource 104.

The definition of an authentic user in this invention is as follows. A user is considered authentic with respect to an identifier 103 if the user can prove current possession of the private key 106 that pairs with the public key 105 contained in the resource 104 that is located by identifier 103.

One embodiment of the present invention enables users to authenticate themselves for the purpose of transacting with a server. In this embodiment, a single authentication procedure establishes a session within which multiple transactions may be invoked without the need for further authentication. The session validity may be restricted by the server, for instance to a fixed period or a fixed type or number of transactions.

This system configuration of this embodiment is illustrated in FIG. 1B. A plurality of instances of components 100 to 107 may exist in any number, additional to those required for the authentication of a particular user by a particular server and the subsequent interaction of that user with that server.

The user may be an individual, computer or other entity. The user is the potential consumer of objects 100 hosted, offered, or protected by a server 101. Objects 100 encompass files, data, or automated services. A server 101 is any system that responds to messages 110 sent by clients 107 according to the protocols described herein. The terms “client” and “server” indicate the roles played by these components only with respect to the described transactions and are not necessarily their exclusive roles.

Resource 104 is exposed to requests 112 made by a server 101 across communications channel 113. The URI of resource 104 is the identifier of the user. Resource 104 contains the user's public key 105.

The private key 106 of the user is stored in, or can be provided to, a client 107. Client 107 is a component controlled directly by the user, for example a computer or process that only the user has access to, or a device such as a smart card or wireless device with the appropriate capabilities.

Alternatively, client 107 is a process on a shared system, for example a component acting as a client 107 on behalf of a plurality of users. Such users might, for example, have credentials registered with the service for the purposes of identifying themselves to it and invoking the service to act as a client 107 on their behalf. A user would in this case need to depend on that client 107 to not reveal the user's private key 106 to any third party, or to employ private key 106 without the consent of the user.

Alternatively, in circumstances where the user is an autonomous or automated process with the capability of acting its own client 107, the terms “client” and “user” may be considered synonymous.

Client 107 sends messages 110 on behalf of the user over a communications channel 111 to server 101. The information required by a server 101 to authenticate the user is derived from a user identifier 103 passed by the client 107 to the server 101, and the resource 104 returned from the network location described by that identifier 103. A server 101 can thus authenticate any user for which it can retrieve a resource 104 described by a user identifier 103.

Servers 101 may, according to their own requirements, grant particular users permission to particular objects 100. This could be achieved by, for example, associating those particular users' identifiers 103 with relevant permissions using access control lists which are well known in the art.

The authentication model is employed by a protocol which defines the content and sequence of messages passing between a client 107 and server 101. These protocols establish the authenticity of a user according to the definition of authenticity provided herein. Following successful authentication, the client 107 may transact with the server 101. At the discretion of the server 101, the identity of the user may determine or affect the outcome of such transactions.

In one such embodiment, the communications channel 111 is exposed, or is potentially exposed, to third parties. In this setting there is a consequent concern about the confidentiality of messages 110. Message encryption is accordingly provided by the protocol.

The protocol is essentially as shown in FIG. 2A and FIG. 2B, with a system configuration as in FIG. 1B.

In another such embodiment, the communications channel 111 is itself encrypted or is inherently private to the client and the server. Whereas the authenticity of a user still needs to be established by the server, in this setting there is no concern about the confidentiality of messages 110, and message encryption is thus not provided by the protocol. This version of the protocol is essentially as shown in FIG. 3A and FIG. 3B, with the system configuration shown in FIG. 1B.

The embodiment of FIG. 2A and FIG. 2B where the communications channel 111 is potentially exposed to third parties is the more comprehensive and will be described first. In neither embodiment does the communications channel 113 need to be confidential, as resource 104 is considered to only contain information which may be publicly distributable.

In FIG. 2A, the parties to the electronic transaction are a client 107, a server 101, and a resource 104. Messages pass between the client 107 and server 101 across a communications channel 111.

Requests for the resource 104 pass from the server 101 to the resource 104 across a communications channel 1113. Neither of communications channel 111 or communications channel 113 are confidential.

The client initiates the protocol by sending the user's identifier to the server (200). The identifier is the literal representation of a URI. The server requests the resource from the location described by the user identifier (201). The resource is returned (202), and the server extracts the public key PUB from the resource (203). The server generates a session index S (204) that is unique within the server's list of session records. Preferably, session index S is highly unlikely to have been previously issued by the server. The server also generates a secret session key K (205), using a random number generator or other means to provide a random number seed. K acts as a key for symmetric encryption. Symmetric key encryption is conventional and a well known process in the art.

The server creates a session record [K, URI, “FALSE”] indexed by the session index S (206). The value “FALSE” indicates that the session is not yet considered valid. The server encrypts the secret session key K using the public key PUB (207). The server concatenates this with the session index S and sends the result to the client (208).

To complete the authentication of the user, the client now demonstrates to the server that it possesses the user's private key. The client decrypts {K}_{PUB} using the user's private key (209). The client now knows the secret session key K, and uses this to encrypt the session index S (210). The client concatenates {S}_{K} with the session index S and sends the result to the server (211). The server retrieves the session record [K, URI, “FALSE”] indexed by S. (212). If no such record exists, the process fails. Otherwise, the server retrieves the secret session key K from the session record (213). The server uses K to decrypt the value {S}_{K} received from the client. If this result equals S, the client has proved that it has the user's private key, as there would otherwise have been no possibility of it extracting K from {K}_{PUB}, and in turn no possibility of it generating {S}_{K}. In this case, the server sets the session record indexed by S to [K, URI, “TRUE”]. The value “TRUE” indicates that the session is valid. The server may attach information to this session record to indicate under which circumstances to render it invalid.

FIG. 2B illustrates the process by which the client may now transact with the server. The client formulates a request R (220), for instance specifying a resource, posting data, or asserting a procedure call. The client encrypts the request R with the secret session key K to produce {R}_{K} (221). This is concatenated with session index S and dispatched to the server (222). The server retrieves the session record [K, URI, “TRUE”] indexed by S (223). If no such record exists, the process fails. Otherwise, the server retrieves the secret session key K (224) from the session record. The server uses K to decrypt the value {R}K received from the client (225). In the final step (226) the server executes the request R. In doing so, the server may refer to access control information or other attributes that it may have associated with the user identified by the URI in the session record, in order to process the request R in a manner specific to that user.

The embodiment of figure FIG. 3A and FIG. 3B are described primarily with respect to differentiating features resulting from the case where communications channel 111 is inherently confidential. In this embodiment, messages that pass between the client 107 and server 101 are not encrypted by the protocol itself.

The client sends the user's identifier to the server (300). The server requests the resource from the location described by the user identifier (301). The resource is returned (302), and the server extracts the public key PUB from the resource (303). The server generates a unique session index S (304). Preferably, session index S is highly unlikely to have been previously issued by the server. Also, session index S is preferably from a large enough number range to be unfeasible to guess using practically available methods. The server creates a session record [URI, “FALSE”] indexed by the session index S (305). The value “FALSE” indicates that the session is not yet valid. The server encrypts the session index S using the public key PUB (306), and sends the result to the client (307).

To complete the user authentication, the client now demonstrates to the server that it possesses the user's private key. The client decrypts the value {S}_{PUB} using the user's private key (308). The client now knows the session index S, which it sends to the server (309). The server retrieves the session record [URI, “FALSE”] indexed by S (310). If no such record exists, the process fails. Otherwise, the client has proved it has the user's private key, as there would otherwise have been no possibility of knowing the session index S. In this case, the server sets the session record indexed by S to [URI, “TRUE”] (311). The value “TRUE” indicates that the session is valid. The server may attach information to this session record to indicate under which circumstances to render it invalid.

FIG. 3B illustrates the process by which the client may now transact with the server. The client formulates a request R (320). The client concatenates R with the session index S (321), and this is sent to the server (322). The server retrieves the session record [URI, “TRUE”] indexed by S (323). If no such record exists, the process fails. Otherwise, in the final step (324) the server executes the request R. In doing so, the server may refer to access control information or other attributes that it may have associated with the user identified by the URI in the session record, in order to process the request R in a manner specific to that user.

Another embodiment of the present invention enables an authenticable user A to send a confidential message to a user B, such that only user B may read the message. The message may be of a human-readable type, or of a type that is machine readable for application specific purposes such as system-level notification or invocation of automated processes.

Each message contains information required to authenticate the sender and ensure that only the recipient may decrypt the message.

The system configuration of this embodiment is show in FIG. 4A. In this embodiment there is no notion of a session. User A employs a client 400 to send a message to user B's server (401). Users may be individuals, computers or other entities. The terms “client” and “server” indicate the roles played by these components for the purpose of this transaction only, and are not necessarily their exclusive roles. These components might for instance also allow user B to send a message to user A, in which case their roles would be considered reversed.

Client 400 acts on behalf of user A, and stores or can be provided with user A's private key 409. Client 400 is able to make requests 404 across communications channel 414 for a resource 405, which contains the public key 410 of user B. The URI of resource 405 is the identifier of user B.

Client 400 sends messages 402 across a communications channel 415 to server 401. The communications channel 415 is not required to be confidential in order to ensure the confidentiality of messages 402.

Server 401 receives messages on behalf of user B, and stores or can be provided with user B's private key 411. Server 401 is able to make requests 406 across a communications channel 416 for a resource 407, which contains the public key 408 of user A. The URI of resource 407 is the identifier of user A.

Communications channels 414 and 416 need not be confidential, as resources 405 and 407 are considered to only contain information which may be publicly distributable.

The protocol is essentially as shown in FIG. 4B. A message M is formulated on user A's client (420). A one-way hash of message M is created, then encrypted using the private key of user A. This forms a digital signature of message M (421). One-way hash algorithms and digital signatures are conventional and well known processes in the art.

The client requests the resource at the URI acting as user B's identifier (422). The resource is returned (423), and the client extracts user B's public key PUB_{B} from the resource (424). The client also generates a secret key K (425), and encrypts K with PUB_{B} (426). The client concatenates the message M with the digital signature, and encrypts the result with the secret key K (427). The client then concatenates the URI that acts as user A's identifier, the URI that acts as user B's identifier, the secret key encrypted with B's public key, and the encrypted concatenation of message M and the digital signature. This is sent to the server (428).

The server recognises the message as being intended for user B. The server decrypts the encrypted secret key K using the private key of user B (429). The server uses the secret session key K to decrypt the concatenation of message M and the digital signature (430). The server requests the resource from the URI that is user A's identifier (431). The resource is returned (432), and the server extracts user A's public key PUB_{A} from the resource (433). The server decrypts the digital signature using the PUB_{A} (434). The server creates a cryptographic hash of message M, and compares the result with the decrypted signature (435). If they are identical, the message is considered to originate from the authentic user A. In this case the server accepts or otherwise processes the message, accord to its type (436).

The embodiments described herein illustrate functional elements of larger systems or processes that depend on the identification and authentication of users. Their commonality is the employment of identifiers that simultaneously identify a user and describe the location of cryptographic material which may enable the authenticity of the user to be established.

While the invention has been described in connection with what is presently considered to be the most practical and preferred embodiments, it is to be understood that the invention is not to be limited to the disclosed embodiments, but is on the contrary intended to cover various modifications and equivalent arrangements included within the spirit and scope of the appended claims.

1. A method for naming and authenticating a user comprising of an identifier with the combined functions of:
(a) acting literally as the identity of the user, and
(b) describing the location of a public cryptographic key,
such that the user's possession of the associated private cryptographic key establishes the authenticity of the user with respect to the identifier.

2. The method of claim 1 where a client acts on behalf of a user to authenticate the user to a server, and to allow the user to interact with the server.

3. The method of claim 2 where a user claiming a particular identity is authenticated by a server by retrieving the public cryptographic key at the location described by the user's claimed identity, using it to encrypt some data, and challenging the client to decrypt the data using the associated private cryptographic key.

4. The method of claim 3 where the data is a key for the encryption of subsequent communications between the client and the server.

5. The method of claim 1 where a message is sent between two users, the message being able to be decrypted only by the recipient, and the message containing a signature authenticating the identity of the sender.
